(19) United States
(12) Patent Application Publication
(10) Pub. No.: US 2002/0090929 A1
(43) Pub. Date: Jul. 11, 2002

(54) Radio terminal utilizing an user image as locking function

(75) Inventor: Bum-Seok Cho, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/974,655

(22) Filed: Oct. 9, 2001

(30) Foreign Application Priority Data
Jan. 11, 2001 (KR) 2001-1618

(51) Int. Cl. H04M 1/66

(52) U.S. Cl. 455/410; 455/551; 455/556

(57) ABSTRACT

A radio terminal having a locking function is provided and includes a photographing unit for capturing a user image to generate a pattern image of the user image; a memory for storing the pattern image of the user image; and a controlling unit for comparing the pattern image of the user image, from the photographing unit, with a pattern information of a reference user image stored in the memory, wherein the controlling unit cancels the locked state of the radio terminal, if the pattern information of the reference user image is the same as the pattern image of the user image.

### PRIORITY

This application claims priority to an application entitled “RADIO TERMINAL HAVING A LOCKING FUNCTION VIA USER IMAGE” filed with the Korean Industrial Property Office on Jan. 11, 2001 and assigned Serial No. 2001-1618, the contents of which is hereby incorporated by reference.

### BACKGROUND OF THE INVENTION

1. Field of the Invention

The present invention relates to a radio terminal, and more particularly, to a radio terminal having a locking function.

2. Description of the Related Art

In general, there are frequent occurrences of the loss or theft of portable terminals such as radio terminals, portable information terminals, such as PDAs (Personal Digital Assistants), composite radio terminals having the radio terminal and the portable information terminal incorporated thereto, etc., because they are small, which makes them easier to lose or steal without attracting attention. Due to the loss or theft of such portable terminals, others, who are not the real owners of the terminals, can frequently use these portable terminals. Specifically, when there is a loss or theft of the radio terminals or composite radio terminals, the real owners may be forced to pay charges associated with the loss or stolen radio terminals, such as when others call or communicate with the lost portable terminal, thereby causing not only damage to the owners' psyche but also an economic injury to the owners.

Therefore, a number of methods have been proposed to prevent the use of portable terminals by non-owners of the terminals. For example, a typical prevention method utilizes a password, so that only the user who knows the password can use the portable terminal.

FIG. 1 illustrates a process for setting a locking function in a radio terminal of the related art, and FIG. 2 illustrates a process for canceling a locking function in a radio terminal of the related art.

Referring to FIG. 1, a user of the radio terminal selects the locking function of the radio terminal, in step 20. Next, in step 22, the user inputs and stores a password, which disables others from using certain functions of the radio terminal. Then the user completes setting the locking function of the radio terminal, in step 24.

Referring to FIG. 2, in this case the user utilizes the locked radio terminal to input a registered password, in step 30. Then, the radio terminal compares the inputted password with the pre-stored password, in step 32. The radio terminal allows the user to cancel the locked function, in step 34, if the password inputted, in step 32, is identical with the stored password. In step 36, if the password is not identical with the pre-stored password, then the locked state is maintained.

According to this aforementioned technology, however, there is an inconvenience to the user because the user must memorize the password and re-input the password whenever the radio terminal is in use. In addition, if the password is leaked to others, the locking function of the radio terminal becomes useless.

### SUMMARY OF THE INVENTION

It is therefore an object of the present invention to provide a radio terminal, which can utilize a user image to restrict use of the terminal.

According to an embodiment of the invention, to obtain the object, there is provided a radio terminal having a locking function, comprising: a photographing unit for capturing a user image to generate a pattern image of the user image; a memory for storing the pattern image of the user image; and a controlling unit for comparing the pattern image of the user image from the photographing unit with a pattern information of a reference user image stored in the memory, wherein the controlling unit cancels the locked state of the radio terminal, if the pattern image of the user image is identical to the pattern information of the reference user image.

### BRIEF DESCRIPTION OF THE DRAWINGS

The above and other objects, features, and advantages of the present invention will become more apparent in light of the following detailed description of an exemplary embodiment thereof take in conjunction with the attached drawings in which:

FIG. 1 illustrates a process for setting a locking function in a radio terminal of the related art;

FIG. 2 illustrates a process for canceling a locking function in a radio terminal of the related art;

FIG. 3 is a block diagram of a radio terminal, according to a preferred embodiment of the invention; and

FIG. 4 is a flow chart for canceling a locking function via a user image in the radio terminal, according to the preferred embodiment of the invention.

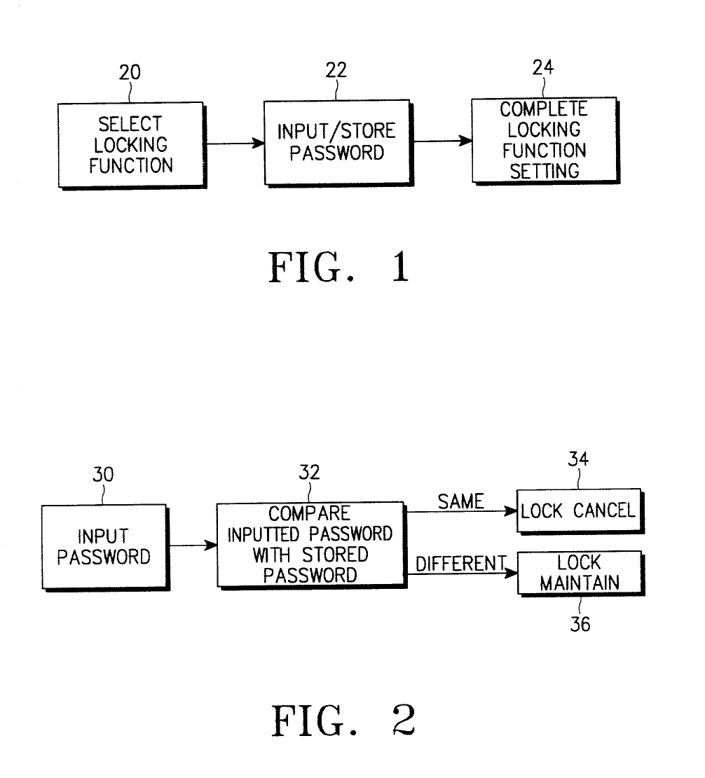

### DETAILED DESCRIPTION OF THE PREFERRED EMBODIMENTS

Hereinafter there will be described in detail a preferred embodiment of the present invention with reference to the appended drawings. While a number of specific elements such as a detailed configuration or a process flow of a portable terminal are shown in the following specification and the appended drawings, it should be apparent to those skilled in the art that these specific elements are provided only for the overall understanding of the invention and the invention can be performed without these specific elements. In addition, detailed descriptions will be omitted about known functions and configurations that may unnecessarily obstruct the aspect of the invention.

In the present invention, it is proposed that a user can restrict others from using his/her radio terminal by using an image, which is specific for each person. Accordingly, the invention provides the radio terminal with a photographing unit, in which the radio terminal compares a pattern image of a user image captured by the photographing unit with a pattern information of a reference user image, previously stored, in a memory of the radio terminal and permits the use thereof, only if the pattern image of the user image is identical to the pattern information of the reference user image.

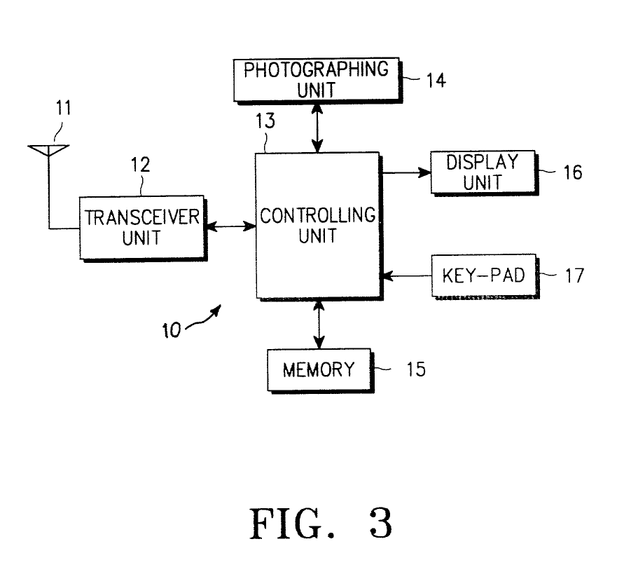

FIG. 3 is a block diagram of a radio terminal, according to a preferred embodiment of the invention for showing those components related to the invention only. A radio terminal 10 is comprised of: an antenna 11, a transceiver unit 12, a controlling unit 13, a photographing unit 14, a memory 15, a display unit 16 and a key pad 17. Those of ordinary skill in the art recognize that there are more elements in a radio terminal than those recited above. Controlling unit 13 of the radio terminal performs the general control operation of the radio terminal. In addition, the controlling unit 13 compares a pattern image of a user image, captured by a photographing unit 14, with a pattern information of a pre-stored reference user image, in order to control a locking function of the radio terminal, according to the result of comparison. More particularly, the controlling unit 13 cancels the locked state of the radio terminal, if the pattern image of the user image, captured by the photographing unit 14, is identical or the same as the pattern information of the reference user image stored in a memory 15. If the pattern image of the user image is not identical or the same as the pattern information of the reference user image, then the lock state of the radio terminal is maintained. The photographing unit 14, which captures the user image can be a camera or a lens or any device that is able to duplicate a photographic image. In addition, in the case of a visual radio terminal, the photographing unit 14 can be replaced by a component, which is installed in the visual radio terminal by utilizing a photographing function.

Transceiver unit 12, under the control of the controlling unit 13, controls the transmission/receipt of voice and information data. Display unit 16, under the control of the controlling unit 13, displays a number of messages and images. In addition, display unit 16 can be an LCD (Liquid Crystal Display) or any other device that is capable of displaying an image. The memory 15 includes a program memory section for storing a program for the locking function, via a user image, and a data memory section, for storing data generated during the functional operation by the user or controlling unit 13. Also, the memory 15 includes a memory area, which stores the user image captured by the photographing unit 14.

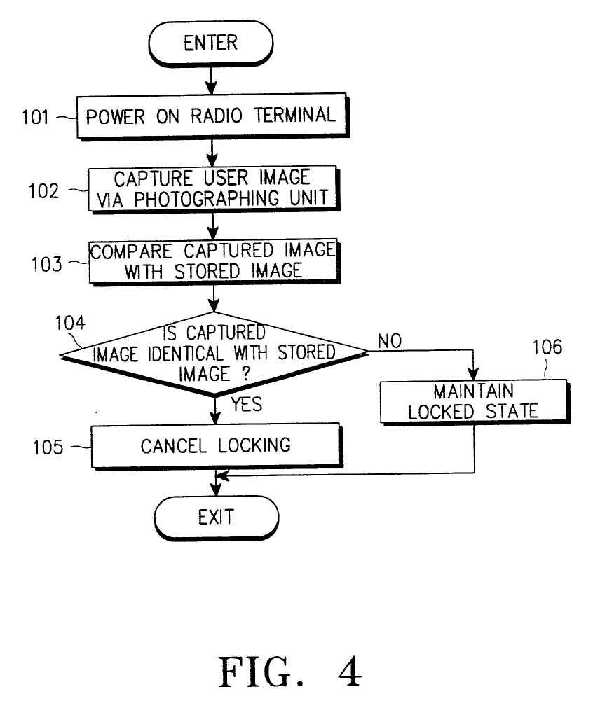

FIG. 4 is a flow chart that depicts the cancellation of the locking function, via a user image, in the radio terminal, according to the preferred embodiment of the invention. Hereinafter the operation of the radio terminal, according to the preferred embodiment of the invention, will be described in reference to FIG. 4.

First, the user of the radio terminal 10 stores his/her image in the memory 15, via the photographing unit 14, by selecting the locking function of the radio terminal. Then the user utilizes his/her image to cancel the locked state of the radio terminal in order to prevent others from using the radio terminal. Preferably, the user image stored is the user's face, but can be any identifying image, such as a piece of jewelry the user always wears, a specific piece of clothing the user wears, a specific body part, etc.

Referring to FIG. 4, the radio terminal is powered ON by the user, in step 101. The radio terminal is automatically locked, while being powered ON to effectively prevent others from using the radio terminal. If the radio terminal is not locked at the time of powering ON, others can easily use the radio terminal. In step 102, the radio terminal 10 captures the user image, via the photographing unit 14, and processes the pattern image of the user image, via the controlling unit 13. Then in step 103, the radio terminal 10 compares the present pattern image of the user image, captured by the photographing unit 14, with the pattern information of the reference user image stored in the memory 15, and determines if the pattern image of the user image is identical or the same as the pattern information of the reference user image, in step 104. In step 105, the radio terminal 10 cancels the locked state, if the captured pattern image of the user image is the same or identical to the stored image of the user in step 104. Alternatively, if the captured pattern image of the user is not the same as the stored image of the user, then in step 106, radio terminal 10 maintains the locked state to prevent anyone from utilizing the radio terminal.

In addition, the radio terminal of the invention can update the user image used for the locking function. Since the user image can be changed or updated, for example according to hairstyle, accessories, etc., the user can re-capture and store the user image via the photographing unit of the radio terminal, when the update occurs.

As described hereinbefore, the present invention restricts others from using the radio terminal by using the user image, which is specific to each person. According to the invention to obtain this, the photographing unit 14 further comprises the radio terminal 10, and can be used only if the pattern image of the user image, captured by the photographing unit 14, is identical to the pattern information of the reference user image stored in the memory 15, according to the comparison thereof. Therefore, the invention can effectively prevent others from using the radio terminal without discomforting the user.

According to the invention, the radio terminal has a locking function using a user image so that any use by others can be effectively prevented without discomforting the user.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A radio terminal having a locking function, comprising:
a photographing unit for capturing a user image to generate a pattern image of the user image;
a memory for storing the pattern image of the user image; and
a controlling unit for comparing the pattern image of the user image from the photographing unit with a pattern information of a reference user image stored in the memory, wherein the controlling unit cancels the locked state of the radio terminal, if the pattern information of the reference user image is the same as the pattern image of the user image.

2. A radio terminal having a locking function according to claim 1, wherein said controlling unit maintains the locked state of the radio terminal, if the pattern information of the reference user image is not the same as the pattern image of the user image.

3. A method for locking and unlocking a radio terminal, which includes a photographing unit for capturing a user image and a memory for storing a pattern image of the user image captured by the photographing unit, the method comprising:
capturing the user image by the photographing unit, if the radio terminal is powered ON;
comparing a pattern image of the user image, captured by the photographing unit, with a pattern information of a reference user image stored in the memory; and
canceling the locked state f the radio terminal, if the pattern information of the captured user image is the same as the pattern information of the stored reference user image.

4. A method for locking and unlocking a radio terminal according to claim 3, wherein the memory pre-stores the pattern image of the user image captured by the photographing unit.

5. A method for locking and unlocking a radio terminal according to claim 4, further comprising maintaining the locked state of the radio terminal, if the pattern image of the captured user image is not the same as the pattern information of the stored reference user image.

6. A method for locking and unlocking a radio terminal according to claim 3, further comprising updating the pattern image of the captured user image.

7. A method for locking and unlocking a radio terminal having a photographing unit and a memory, comprising:
capturing a reference image by utilizing the photographing unit;
storing the reference image in the memory;
upon powering ON the terminal, utilizing the photographing unit to capture an input user image;
comparing the reference image to the input user image;
maintaining a locked state of the terminal, if the reference image and the input user image are not the same; and
canceling the locked state of the terminal, if the reference image and the input user image are the same.
